(19) United States
(12) Patent Application Publication
(10) Pub. No.: US 2007/0186076 A1
(43) Pub. Date: Aug. 9, 2007

(54) DATA PIPELINE TRANSPORT SYSTEM

(76) Inventor: Anthony Mark Jones, Beaverton, OR (US)

Correspondence Address: AMBRIC, INC.;C/O MARGER JOHNSON & MCCOLLOM PC, 210 SW MORRISON STREET, SUITE 400, PORTLAND, OR, 97204, US

(21) Appl. No.: 11/735,390

(22) Filed: Apr. 13, 2007

Related U.S. Application Data
(63) Continuation-in-part of application No. 10/871,347, filed on Jun. 18, 2004, now Pat. No. 7,206,870.
(60) Provisional application No. 60/479,759, filed on Jun. 18, 2003.

(51) Int. Cl. G06F 15/00

(52) U.S. Cl. 712/1

(57) ABSTRACT

A series of pipeline stages are interconnected with other similar stages in arbitrary topologies. Data travel is controlled and regulated by forward and back-pressure mechanisms.

### CROSS REFERENCE TO RELATED APPLICATIONS

This application claims the benefit of and is a continuation-in-part of co-pending U.S. application Ser. No. 10/871,347, filed Jun. 18, 2004, entitled DATA INTERFACE FOR HARDWARE OBJECTS, now U.S. Pat. No. 7,206,870, to issue Apr. 17, 2007, which in turn claims the benefit of U.S. provisional application 60/479,759, filed Jun. 18, 2003, entitled INTEGRATED CIRCUIT DEVELOPMENT SYSTEM, the teachings of both of which are hereby incorporated by reference.

### TECHNICAL FIELD

This disclosure relates to a system for a data pipeline stage that can be interconnected with other, similar, stages in arbitrary topologies. Facilities for exerting both forward and backward dataflow pressure are included, as is the use of a back data channel.

### BACKGROUND

Modern data processing circuits, including Digital Signal Processors (DSPs), Microprocessors, Field Programmable Gate Arrays (FPGAs), and Application Specific Integrated Circuits (ASICs) internally transfer large amounts of data, typically in data streams. These streams are carried by data pipelines, which are made from a connected series of separate storage elements, known as stages. Circuitry between each separate stage of the pipeline may operate on the data before sending it to the next stage. Data pipelines are almost always unidirectional, but can be connected in many different topologies that may include feedback flows.

The simplest controllable pipeline that can be constructed is a linear set of pipeline stages where each stage is simply a set of data flip-flops. This pipeline acts as a fixed delay element. With reference to FIG. 1, each of a set of flip-flops 50 are exactly the data width of the system, for example 8 bits, and are each clocked on the positive edge of a global system clock that is not shown. FIG. 1 shows a four-stage linear pipeline 56, where each of the flip-flops 50 holds a single piece of data. The pipeline 56 holds four pieces of data at any instant, and it takes four clock cycles for any single element of data to move through the entire pipeline, yielding a fixed delay of four from input to output

The pipeline 56 of FIG. 1 can easily be modified to allow the output to be stopped without losing any of the data. This is a form of “back pressure”, which controls the flow of data and requires that the input source must also have the ability to be stopped. With reference to FIG. 2, a signal IN ENABLE signal is used, which is globally transmitted to each of a set of flip-flips 60 and becomes the OUT ENABLE signal that halts the transmitting machine (not shown) at the input side of a pipeline 66. The IN ENABLE signal initiates at the exit side of the pipeline 66. Buffers 61 illustrate that some data buffering is usually required, based on the signal distance and the number of stages the OUT ENABLE signal controls. Multiplexers 62 are shown as a simple AND-OR structure, with the output of two AND gates combined by a 2-input OR gate. Note that the IN ENABLE signal, through the multiplexers 62, controls where each stage of the flip-flops 60 receives its input—either from the preceding stage, or from the output of the particular flip-flop 60 itself. This back pressure scheme is very common, but suffers from a number of serious drawbacks when building real-world systems:

First, as described here, the global nature of the ENABLE signal demands that the signal propagates to each of the multiplexers 62 in a single clock cycle. For a short pipeline, this is an acceptable criterion, but for long pipelines in arbitrary topologies the generation and distribution of the ENABLE signal within the allowed (single cycle) time is very difficult.

Second, there is only one source that makes the decision to stop the pipeline, located at the exit side of the pipeline. This means that every stage in the pipeline controlled by such a signal must stop on demand, regardless of whether any particular stage within the pipeline can continue processing.

With reference to FIG. 3, the pipeline 66 of FIG. 2 can be extended so that the data transmission is not required on every cycle. This means that each piece of data must be tagged with a bit that indicates whether the datum being described, held in one of the flip-flops 70, 72, 74, or 76, is useful or not. This tag is denoted the VALID bit in FIG. 3.

Each of the VALID bits describes whether the associated data is deemed proper for inclusion in whatever process is currently in operation. For instance, if a particular process would require three clock cycles to generate a data result, the VALID bit would be de-asserted for the first two cycles, and then asserted during the third. A de-asserted VALID bit does not indicate that there is no data stored in the associated flip-flop, as the flip-flop may hold stale data from an earlier cycle. Rather, a de-asserted VALID bit indicates that any data held in the associated flip-flop is not a legitimate value, and not to be computed on.

The inclusion of logic gates 90, 92, 94 and 96 allow illegitimate or empty data to be compacted when the pipeline is stopped. Each stage 100 in a pipeline 106 is identical and can be considered as a separate unit entity. For example, if the VALID tag flip-flop 84 is de-asserted (that is, the associated data flip-flop 74 is empty or holds non-useful data), the associated logic gate 94 will assert the local ENABLE signal 95 even when the last stage 100 in the pipeline 106 system is stopped (i.e., when both signals IN ENABLE and signal 97 are de-asserted). Thus logic gate 94 allows state 74, 84 to be updated with new data even when the system as a whole is stopped. The logic shown in FIG. 3 has three important features to note:

First, the VALID tags 80, 82, 84 and 86 allow push-forward pressure relief; Second, the VALID tags 80, 82, 84 and 86 are simply an extension to their associated data and are not treated differently; and Third, each of the pipeline stages 100 locally determines its own stopping behavior.

The potential timing problem of the pipeline 66 FIG. 2 is not improved in the system of FIG. 3, where the buffers 61 (FIG. 2) are simply replaced by more complex combinatorial gates 90, 92, 94 and 96 (FIG. 3). Instead, the pipeline 106 of FIG. 3 has been constructed so that the advantage of purely local determination in each pipeline stage 100 can be seen.

Embodiments of the invention address these and other limitations in the prior art.

### BRIEF DESCRIPTION OF THE DRAWINGS

FIG. 1 is a circuit diagram of a four-stage linear pipeline, comprising four edge-triggered flip-flops clocked by a global system clock according to the prior art.

FIG. 2 is a circuit diagram of a four-stage linear pipeline similar to that of FIG. 1 with the addition of a global stop signal, according to the prior art.

FIG. 3 is a circuit diagram of a four-stage linear pipeline with a data validity tag and a global stop signal, according to the prior art.

FIG. 4 is a circuit diagram of a single pipeline stage using a localized state machine for control, according to embodiments of the invention.

FIG. 5 is a circuit diagram of a single pipeline stage with a re-timed stop signal according to embodiments of the invention.

FIG. 6 is a circuit diagram of a completely localized pipeline stage with both push-forward and push-back state, according to embodiments of the invention.

FIG. 7 is a circuit diagram of a latch-based version of a completely localized pipeline stage with both push-forward and push-back state, according to embodiments of the invention.

FIG. 8 is a timing diagram showing timing signals within the logic shown in FIG. 7.

FIG. 9 is a circuit diagram illustrating a completely localized pipeline stage, with both push-forward and push-back state, using edge-triggered flip-flops, according to embodiments of the invention.

FIG. 10 is a circuit diagram of a completely localized pipeline stage, with both push-forward and push-back state, using level-sensitive latches, according to embodiments of the invention.

FIG. 11 is a circuit diagram of a circuit that minimizes glitch-sensitive circuitry of FIG. 10, according to embodiments of the invention.

FIG. 12 is a circuit diagram of a completely localized pipeline stage, with both push-forward and push-back state, and including a directly controlled back-channel using level-sensitive latches, according to embodiments of the invention.

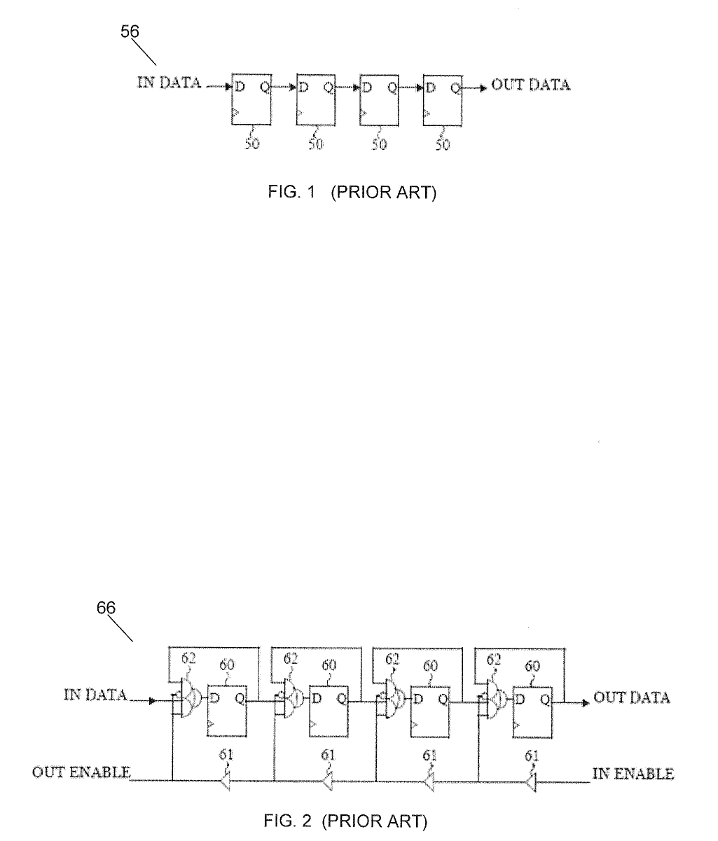

### DETAILED DESCRIPTION

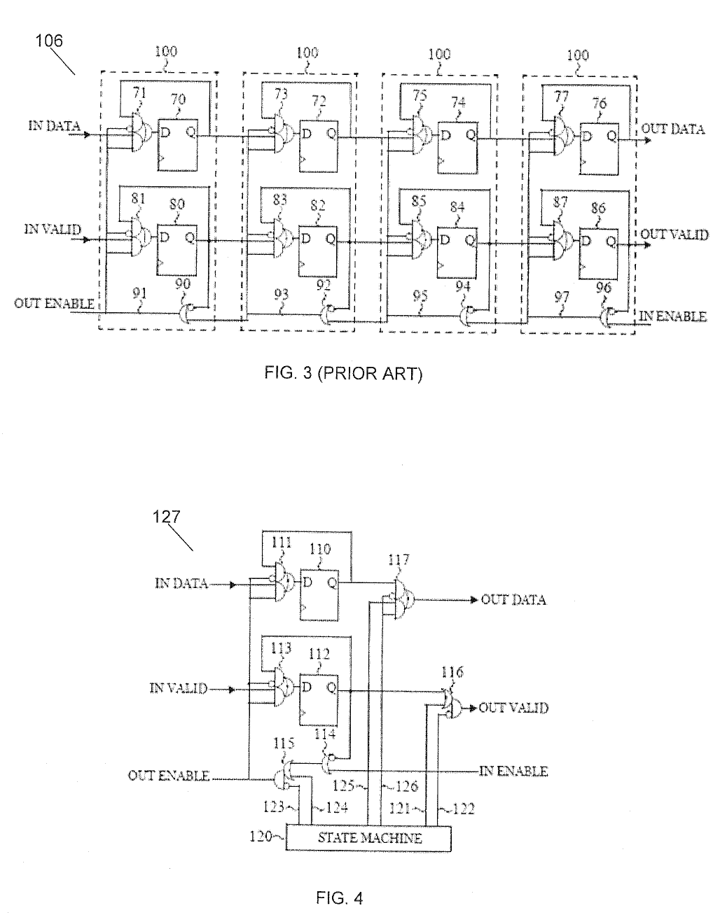

With reference to FIG. 4, an individual stage 127 of a data pipeline is illustrated. In FIG. 4, local behavior is extended over the previous examples to include a state machine for each pipeline stage. Only one pipeline stage 127 is shown for clarity. A state machine 120 can be controlled by any or all of: a pipeline state 110 or 112; a state generated by and/or stored within state machine 120; and signals IN DATA, IN VALID, and IN ENABLE.

The state machine 120 generates any of six output signals, which determine the behavior of the pipeline stage 127 of FIG. 4. Using logic gate 116, the assertion of signal 122 will place an empty (invalid) datum into the next pipeline stage, without regard to the contents of flip-flop 112. Similarly, the assertion of signal 121 will indicate that the output datum is not empty, also without regard to state 112.

The assertion of signal 123 will stop the previous pipeline stage, by de-asserting OUT ENABLE, while the assertion of signal 124 (while signal 123 is de-asserted) guarantees that the DATA state 110 and VALID state 112 will be updated on the next cycle, regardless of both the stored valid state 112 and the value of IN ENABLE.

The multiplexer 117 allows the state machine 120 to insert new data, or replace the value of the data stored in flip-flop 110, by asserting signal 126 and driving a new data value on a bus 125.

By including the state machine 120 in FIG. 4, the control of any pipeline topology n stages deep built using n multiple pipeline stages is distributed into n simple, distinct state machines 120 rather than one global, complex controller for an entire system. Another advantage of the state separation shown in FIG. 4 is that each pipeline stage 127 can be modular in design because no assumptions are made about the state of the previous and subsequent stages—instead, all external state is transmitted through a convenient encoding of IN VALID, IN ENABLE and (in some cases) IN DATA.

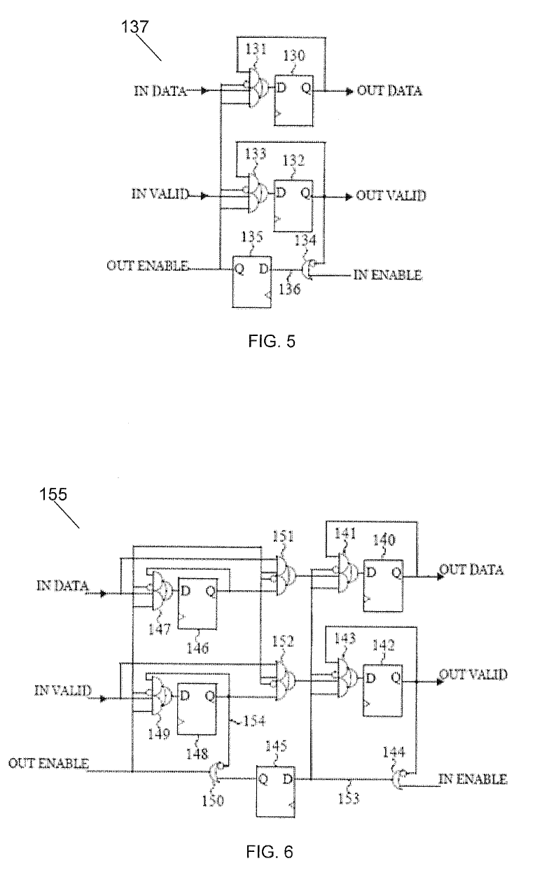

A potential disadvantage of the pipeline stage schema shown in FIG. 4 is that the timing of the IN ENABLE combinatorial logic is worse than for the stages 100 of FIG. 3, and still needs to be distributed globally for the entire pipeline topology. With reference to FIG. 5, the timing of ENABLE can be localized to a stage 137 by using a flip-flop 135, reducing the timing for the entire pipeline to a set of local timings that are essentially from one flip-flop to another. For clarity, the state machine 120 of FIG. 4 is not shown in FIG. 5, but like the logic shown in FIG. 4 can be used to provide signals OUT ENABLE, OUT VALID and OUT DATA.

With further reference to FIG. 5, both the control of timing and the determination of push-forward/push-backward pressures are local. This gives FIG. 5 a modularity that allows pipeline systems of any topology to be constructed by simply plugging multiple instances of FIG. 5 together.

The scheme shown in FIG. 5 has an undesirable feature when the stage is being stopped initially. If signal 136 is de-asserted (meaning OUT DATA is not empty and IN ENABLE has been de-asserted) and the state 135 is still asserted, the pipeline stage updates on that cycle, destroying the states 130 and 132 (which have not yet been transmitted to the following pipeline stage because IN ENABLE is de-asserted). On the next cycle, state 135 becomes de-asserted, but this occurs a cycle too late to preserve the states 130, 132.

The solution to this late cycle is to use a “side register” (also known as a “skid register”) to hold the values temporarily without overwriting the values in the main register. With reference to FIG. 6, flip-flops 146 and 148 are the side registers used to hold incoming data when signal 153 is de-asserted and flip-flop 145 is still asserted. Note that any incoming data is now stored in flip-flops 146 and 148 while the previous state held in flip-flops 140 and 142 is kept intact. The multiplexers 151 and 152 allow the pipeline stage to re-activate the “side register” state when the pipeline stage is started again (when signal 153 is asserted while state 145 remains de-asserted). The addition of logic gate 150 allows any empty “side register” values to be overwritten when the pipeline stage is stopped.

Note that both schemes of FIG. 3 and FIG. 6 can be used in combination with each other. By careful placement of side register pipeline stages (FIG. 6), the global timing of the ENABLE can be divided into a number of manageable sections. The hardware cost of using exclusively the scheme of FIG. 6 for every pipeline stage is approximate doubled, due to the addition of the side registers 146, 148.

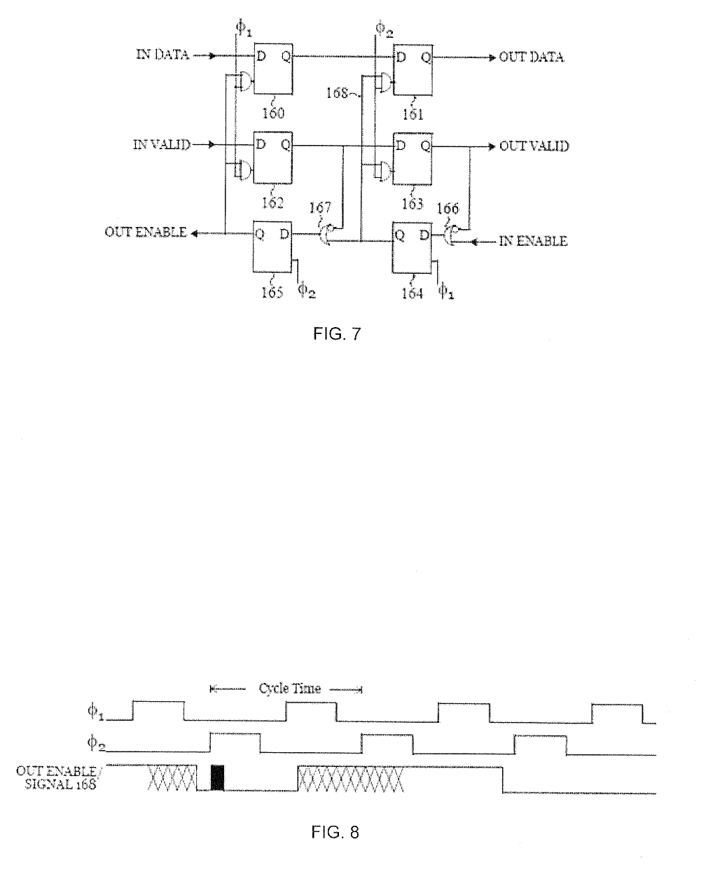

Because edge-triggered flip-flops are constructed using a master-slave configuration of two level-sensitive latches, the hardware cost of FIG. 6 can be reduced by controlling the component latches of flip-flops 140 and 142 independently. Thus, the equivalent to the side registers of FIG. 6. are the master latches of the flip-flops. FIG. 7 shows the equivalent of FIG. 6. using level-sensitive latches 160, 161, 162, 163, 164 and 165. Note that latches 160, 161, 162 and 163 use a gated-clock configuration, indicated by the AND-symbol shown on each latch. The convention of the gated-clock of each latch is that no change in the internal state occurs if the output of the AND-gate remains LOW, and thus both the ENABLE and the clock must be HIGH at the same time for the latch state to change.

One of the essential features of FIG. 7 is the use of a non-overlapping two-phase clock. The two phases are labeled φ1 and φ2 and are generated such that they are never simultaneously HIGH. The lack of overlap ensures that the master-slave latch pairs (160,161), (162,163) and (164,165) are never both accepting data as input at the same time, which would effectively short the input to the output.

Apart from the care needed to generate the non-overlapping two-phase clocks, the circuit of FIG. 7 suffers from another timing difficulty in that the clock enable signals, OUT-ENABLE and signal 168, must de-assert their state early in the cycle, in particular, before the rising edge of φ2. With reference to FIG. 8, if the enable signal goes HIGH, the signal has almost a full clock cycle of φ1 and φ2 to assert. However, if the enable signal goes LOW, the OUT-ENABLE signal must de-assert before the next φ2 phase, essentially less than one-half a clock cycle. This is a strict requirement that makes the timing of FIG. 7 very difficult to meet. If the half-cycle criterion is not met, shown in FIG. 8 as a solid black pulse, the clock-gating is HIGH momentarily, which would unexpectedly update the latch pairs (160,162) or (161,163).

In any pipeline system, it is the forward-pressure and the back-pressure signals, VALID and ENABLE respectively, that are most critical, both for logical operation and for meeting timing. One of the problems is the inherent asymmetry in both FIG. 4 and FIG. 7 (and the possible extensions already shown in FIG. 6) between the VALID and ENABLE signaling. For example, in FIG. 7 the VALID goes through a different type of level-sensitive latch than does the ENABLE. In fact, in FIG. 7, the symmetry is not between VALID and ENABLE, but rather between VALID and DATA. Thus, in FIG. 7 and other similar systems, the VALID tag is treated solely as a marker traveling with each DATA value.

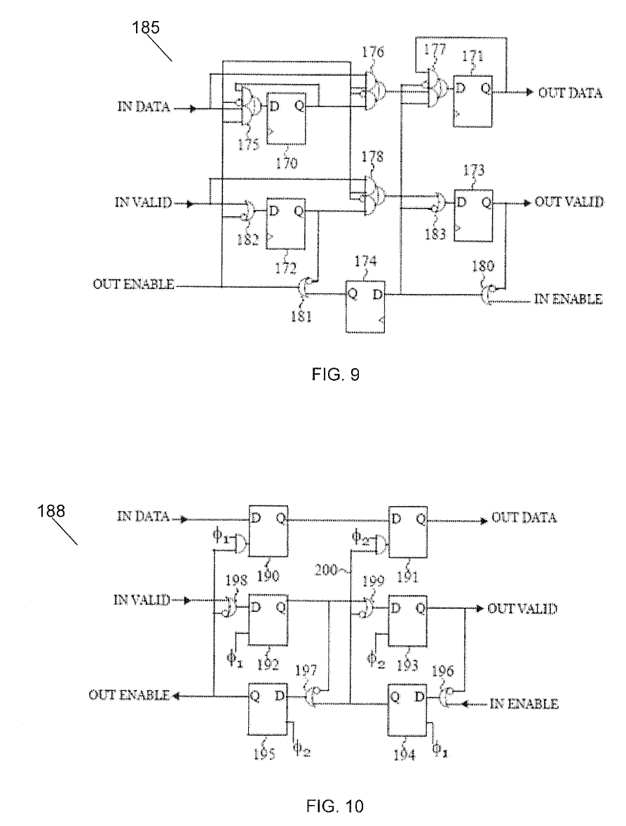

FIG. 9 illustrates a side-register based pipeline stage 185 that overcomes the asymmetry of FIG. 7. In FIG. 9, the VALID and ENABLE are treated identically and VALID no longer is directly associated with the DATA values. With reference to FIG. 9, the logic gates 180 and 181 in the ENABLE path have exact analogues in the VALID path: logic gates 182 and 183.

In most respects, the pipeline stage 185 of FIG. 9 is the same as the pipeline stage 155 of FIG. 6. The main and side data registers 171, 170 of FIG. 9 are equivalent to registers 140, 146 of FIG. 6. Similarly, the VALID main and side registers 173, 172 of FIG. 9 are duplicates of registers 142, 148 of FIG. 6. The ENABLE signal state of FIG. 9 is stored in register 174, while it's equivalent is stored in register 145 of FIG. 6. In those respects, the stages 185 and 155 are identical.

In other respects, the pipeline stages 185 of FIG. 9 and 155 of FIG. 6 are quite different. For instance, the input to the slip register 148 of FIG. 6 is through a multiplexer 149, while the side register 172 of FIG. 9 needs only the logic gate 182. Additionally, the output of the register 142 ties through multiplexer 143 to its input in FIG. 6, while register 173 has no such feedback. A similar lack of feedback for register 172 of FIG. 9 compared to register 148 of FIG. 6 is also evidence of their differences. The importance and advantages of these differences is described below.

Even more striking is the level-sensitive latch version of a pipeline stage 188 shown in FIG. 10. Here the true symmetry between VALID and ENABLE is apparent, with no discernible difference between the VALID and ENABLE except for the direction of travel.

There are two main advantages of FIG. 10 over FIG. 7. First the pipeline stage 188 gives an improvement in timing control of the stage. Second, because of the identical nature of the VALID and ENABLE paths, effectively, either signal could stand for the other in the opposite direction, thus giving the ability to create a low-cost back-channel to carry data in the reverse direction (the direction in which the ENABLE travels). For instance, the OUT VALID symbol could also indicate an IN ENABLE signal for data carried in an opposite direction.

FIG. 10 shows that any timing requirement for the VALID path is identical with the ENABLE path, which reduces the required analysis to only one type of path.

With reference to FIG. 10, critical, glitch sensitive paths of FIG. 7 (clock-gate latches 162, 163) have been eliminated by changing the paths through simple logic gates 198 and 199. Further, the timing of the OUT-ENABLE signal to the gated-clock of latch 190 is never an issue because of the (now clean) timing generated by the simple latches 192, 194, 195 through logic gate 197. This leaves only one potential glitch hazard of the ENABLE changing close in time to when the input changes to the flip-flop: the de-assertion of signal 200 into the clock-gate of latch 191.

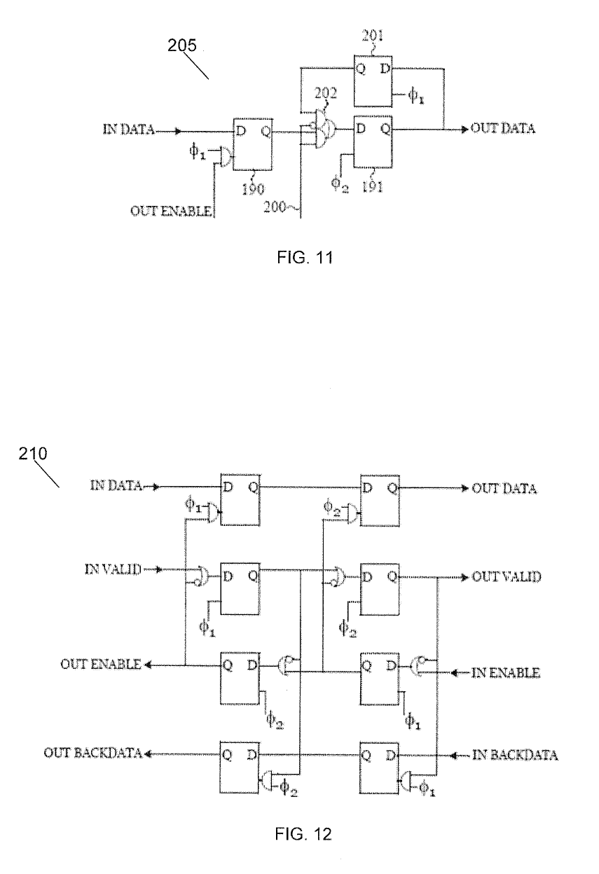

With reference to FIG. 11, a datapath 205 is shown, which is an alternative to the datapath of FIG. 10. The datapath 205 of FIG. 11 includes an extra latch 201 and an additional multiplexer 202 compared to the datapath of FIG. 10. Additionally, the datapath 205 of FIG. 11 combines latches 191 and 201 into an edge-triggered flip-flop to remove the glitch hazard on signal 200. The schema shown in FIG. 11 can be used in the cases where the timing is difficult, or very tight, for example when the IN_ENABLE signal comes late in the cycle. The schema of FIG. 10 is preferred, due to its lower component count and cost, and can be used in most real-world cases.

With reference to FIG. 12, a pipeline stage 210 for a bi-directional data channel is shown. Note that there is a “forward” channel for DATA as well as a “backward” channel for BACKDATA. Because, as described above with reference to FIG. 10 the protocol signals VALID and ENABLE are carried in identical ways except direction, the schema of FIG. 12 exploits the symmetry of the VALID and ENABLE paths. In most real-world cases, the DATA channel is generally a wide-word (e.g., 16-bits, 32-bits or more) and the BACKDATA channel could be generally smaller, e.g., one or two bits. Thus, the BACKDATA channel could be used for a function such as a flag indicator, which would indicate something about the DATA received at its destination. In these cases, FIG. 12 has a significant reduction in hardware over using two full instances of FIG. 10, one in each direction.

There are tradeoffs, of course, in removing so many extra protocol signals when combining two instances of FIG. 10 into FIG. 12 (i.e. two full sets of protocol signals in each direction versus one set of protocol signals in each direction). For instance, starting the pipeline stage 210 will generate BACKDATA that is un-reliable, because it is impossible for the stage 210 to initialize both VALID and ENABLE into a de-asserted state. Therefore, upon startup, the first data in the BACKDATA channel will be values not sent from the process writing to BACKDATA, but rather the values in each pipeline stage comprising the BACKDATA channel.

Several procedures can be used to overcome the tradeoffs, however. For instance, the receiver of the BACKDATA can be instructed to simply not use an initial number of data after reset. In a solution that uses slightly more hardware, a special ‘tag’ bit could travel along with the BACKDATA to indicate a specific order of data. In another solution, the sender of the forward DATA may look for a response at a particular time (e.g., after so many cycles) or with a particular encoding that indicates the receiver of the forward DATA has received it correctly. In other embodiments, the receiver may look to transitions in the data values to indicate that the BACKDATA channel is carrying useful, valid data, or even use simple digital filtering techniques to remove the ‘noise’ data after reset There are other procedures available that are well within one skilled in the art of data communication to handle such startup cases.

From the foregoing it will be appreciated that, although specific embodiments of the invention have been described herein for purposes of illustration, various modifications may be made without deviating from the spirit and scope of the invention.

Accordingly, the invention is not limited except as by the appended claims.

What is claimed is:

1. A data pipeline element, comprising:
a data register and subordinate data register to independently store data words;
a first protocol register to store a value to indicate the existence of a consumable data value in the data register; and
a subordinate first protocol register to store a value to indicate the existence of a consumable data value in the subordinate data register; and
a second protocol register having an input coupled to the data register and the first protocol register, and having an output coupled to the subordinate data register and the subordinate first protocol register;
wherein at least two of the registers in the pipeline element are edge triggered and are updated on the same edge of a clock signal.

2. A pipeline element according to claim 1, in which the second protocol register stores an enable signal.

3. A pipeline element according to claim 1, in which the output of the second protocol register is structured to select when the subordinate data register and subordinate first protocol register are to be updated with new values.

4. A pipeline element according to claim 1, in which the output of the second protocol register is structured to select either the output of the subordinate data register or a data input to the data register.

5. A pipeline element according to claim 1, in which the enable signal is structured to select when the data register and first protocol register are to be updated with new values.

6. A pipeline element according to claim 1, in which all of the registers in the pipeline element are edge triggered and updated on the same edge of the clock signal.

7. A pipeline element according to claim 1, further comprising an update circuit structured to always update the data register and first protocol register with new values whenever there is invalid data in the data register.

8. A pipeline element according to claim 7, further comprising a second update circuit structured to always update the subordinate data register and subordinate protocol register with new values whenever there is invalid data in the subordinate data register.

9. A data pipeline element, comprising:
a data register and subordinate data register to independently store data words;
a first protocol register to store a value to indicate the existence of a consumable data value in the data register; and
a subordinate first protocol register to store a value to indicate the existence of a consumable data value in the subordinate data register; and
a second protocol register having an input coupled to the data register and the first protocol register, and having an output coupled to the subordinate data register and the subordinate protocol register;
wherein a signal path of an input signal for the subordinate data register has a different logical structure than a signal path of an input signal for the subordinate protocol register.

10. A pipeline element according to claim 9, in which the logical signal path of the input signal for the subordinate first protocol register is the same logical signal path as a signal path of the input for the second protocol register.

11. A pipeline element according to claim 10, in which the signal path of the input signal for the subordinate first protocol register is in an opposite direction to a signal path of the input for the second protocol register.

12. A pipeline element according to claim 9, in which at least two of the registers in the pipeline element are edge triggered and updated on the same edge of a clock cycle.

13. A pipeline element according to claim 9, in which all of the registers in the pipeline element are edge triggered and updated on the same edge of a clock cycle.

14. A pipeline element according to claim 9, in which the output of the second protocol register is structured to select when the subordinate data register is to be updated with new values.

15. A pipeline element according to claim 9, in which the output of the second protocol register is structured to select either the output of the subordinate data register or a data input to the data register.

16. A pipeline element according to claim 9, in which the input to the second protocol register is structured to select when the data register is to be updated with new values.

17. A pipeline element, comprising:
a first clock signal and a second clock signal having time distinct phases that do not overlap;
a master data latch and slave data latch to independently store data words;
a master first protocol latch to store a value to indicate the existence of a consumable data value in the master data latch; a slave first protocol latch to store a value to indicate the existence of a consumable data value in the slave data latch; and
a master second protocol latch and a slave second protocol latch to each store an enable indicator to indicate that a subsequent pipeline element will consume the value stored in the slave data latch;
wherein the master data latch and slave data latches are clocked by clock signals combined with an enable signal, and wherein the master first protocol latch and the slave first protocol latch are respectively clocked directly by one of the two clock signals.

18. A pipeline element of claim 17, in which the master second protocol latch and the slave second protocol latch are respectively clocked directly by one of the two clock signals.

19. A pipeline element according to claim 17, in which a logic function for an input to the master first protocol latch is identical to a logic function for an input to the master second protocol latch.

20. A pipeline element according to claim 17, in which a logic function for an input to the slave first protocol latch is identical to a logic function for an input to the master second protocol latch.

21. A pipeline element according to claim 17, in which a logic function for an input to the master first protocol latch is identical to a logic function for an input to the slave second protocol latch.

22. A pipeline element according to claim 17, in which a logic function for an input to the slave first protocol latch is identical to a logic function for an input to the master first protocol latch.

23. A pipeline element according to claim 17, in which a logic function for an input to the master second protocol latch is identical to a logic function for an input to the slave second protocol latch.

24. A pipeline element according to claim 17, in which a logic function for an input to the slave first protocol latch is identical to a logic function for an input to the slave second protocol latch.

25. A pipeline element according to claim 17, in which the output of the slave second protocol latch is structured to enable a clock signal for the master data latch.

26. A pipeline element according to claim 17, in which the output of the master second protocol latch is structured to enable a clock signal for the slave data latch.

27. A pipeline element for a bidirectional data pipeline, comprising:
a first clock signal and a second clock signal having time distinct phases that do not overlap;
a master forward data latch and slave forward data latch to independently store data words;
a master reverse data latch and slave reverse data latch to independently store data words;
a master first protocol latch and a slave first protocol latch to each store a respective signal to indicate data transfer may proceed in the forward direction; and
a master second protocol latch and a slave second protocol latch to each store a respective signal to indicate data transfer may proceed in the reverse direction.

28. A pipeline element according to claim 27, in which the master forward data latch is gated by a combination of the first clock signal and an enable signal.

29. A pipeline element according to claim 28, in which the master first protocol latch is gated by the first clock signal directly.

30. A pipeline element according to claim 29, in which the slave forward data latch is gated by a combination of the second clock signal and a second enable signal.

31. A pipeline element according to claim 30, in which the slave first protocol latch is gated by the second clock signal directly.

32. A pipeline element according to claim 28, in which the master reverse data latch is gated by a combination of the first clock signal and a second enable signal.

33. A pipeline element according to claim 32, in which the slave reverse data latch is gated by a combination of the second clock signal and a third enable signal.

34. A pipeline element in a bi-directional data pipeline, comprising:
a first clock signal and a second clock signal having phases that do not overlap;
a set of two forward data master-slave latches;
a set of two reverse data master-slave latches;
a set of two forward protocol master-slave latches; and
a set of two reverse protocol master-slave latches;
wherein the master latches may change their state only at a rising edge of the first clock signal, and wherein the slave latches may change their state only at a rising edge of the second clock signal.

35. A pipeline element according to claim 34, in which logic paths for the forward protocol latches and reverse protocol latches are identical except for direction.

36. A pipeline element according to claim 34, in which logic paths for the forward data latches and reverse data latches are identical except for direction.

37. A method for moving data along a bi-directional data pipeline, comprising:
storing a reverse-flow signal in a master first protocol latch during a first clock phase;
moving the reverse flow signal to a slave first protocol latch during a second clock phase, the second clock phase not overlapping the first clock phase;
storing a forward flow signal in a master second protocol latch during the first clock phase;
moving the forward flow signal in a slave second protocol latch during the second clock phase;
storing data into a forward data master latch during the first clock phase if an output signal from the slave second protocol latch is asserted; and
storing data into a reverse data master latch during the first clock phase if an output signal from the slave first protocol latch is asserted.

38. The method of claim 37, further comprising:
receiving data from an output of the forward data master latch and storing it in a forward data slave latch during the second clock phase if an output signal from the master second protocol latch is asserted.

39. The method of claim 37, further comprising:
receiving data from an output of the reverse data master latch and storing it in a reverse data slave latch during the second clock phase if an output signal from the master first protocol latch is asserted.
